(19) United States
(12) Patent Application Publication
(10) Pub. No.: US 2026/0119150 A1
(43) Pub. Date: Apr. 30, 2026

(54) SUSTAINABILITY SCORING AND RECOMMENDATION FOR APPLICATION SERVICES

(71) Applicant: Kyndryl, Inc., New York, NY (US)

(72) Inventors: Mouleswara Reddy Chintakunta, Allagadda (IN); Umar Mohamed Iyoob, Manor, TX (US); Anand Bandaru, Bangalore (IN); Manish Mitruka, Pune (IN); Anil Babu Boppanna, Bangalore (IN); Omar Odibat, Cedar Park, TX (US); Geetha R Subramanyam, Nagari (IN); Gail Camille Guerrero, Austin, TX (US)

(21) Appl. No.: 18/929,718

(22) Filed: Oct. 29, 2024

(51) Int. Cl. G06F 8/65; G06Q 30/018

(52) U.S. Cl. CPC G06F 8/65; G06Q 30/018

(57) ABSTRACT

Computer-implemented methods are directed to sustainability scoring and recommendation for application services. Aspects include receiving first data, second data, and third data. Aspects also include generating a set of environment-level sustainability scores for an application using the first data, the second data, and the third data. Aspects further include generating an application maturity score using the third data. Aspects also include generating an application sustainability score using the set of environment-level sustainability scores for the application and the application maturity score. Aspects further include generating a recommendation for the application based on the application sustainability score. Aspects also include initiating a modification to a datacenter of the application based on the recommendation for the application.

### BACKGROUND

The present invention generally relates to computer systems, and more specifically, to computer-implemented methods, computer systems, and computer program products configured and arranged for sustainability scoring and recommendation for application services.

During software development and deployment practices, applications progress through multiple stages, such as development to production deployment. Each stage of software development involves different activities, resource consumption, and energy usage. Each stage of the software development and deployment practice has different environmental impacts which can also impact costs associated with the development and deployment of the application. Obtaining data to measure the sustainability performance of an application can be difficult. Additionally, there are no standards of metrics for measuring the sustainability of an application, making comparison across different applications challenging.

### SUMMARY

Embodiments of the present invention are directed to computer-implemented methods for sustainability scoring and recommendation for application services. A non-limiting computer-implemented method includes receiving first data, second data, and third data. The method also includes generating a set of environment-level sustainability scores for an application using the first data, the second data, and the third data, wherein the set of environment-level sustainability scores corresponds to an environment of a group of environments of the application. The method further includes generating an application maturity score using the third data. The method also includes generating an application sustainability score using the set of environment-level sustainability scores for the application and the application maturity score. The method further includes generating a recommendation for the application based on the application sustainability score. The method also includes initiating a modification to a datacenter of the application based on the recommendation for the application.

In one embodiment of the present invention, the third data includes application data. The generating the application maturity score using the application data further includes using application maturity guidelines, contextual data from an industry of the application, and information for layers of the application from the application data.

In one embodiment of the present invention, the first data includes computing infrastructure data, the second data includes datacenter data, and the third data includes application data. The generating the set of environment-level sustainability scores for the application using the first data, the second data, and the third data further includes obtaining a component set that corresponds to the environment from the group of environments of the application, the component set comprising components of the application that are prone to carbon emissions and carbon emission percentages corresponding to the components of the application. The method also includes generating a component sustainability score for the components of the component set that corresponds to the environment from the group of environments of the application using the carbon emission percentages, available sustainable resources from the datacenter data, sustainability and emissions data from the datacenter data, and the application data. The method further includes generating the set of environment-level sustainability scores for the application, wherein environment-level sustainability scores of the set of environment-level sustainability scores is generated using the component sustainability score for the components of the component set that corresponds to the environment from the group of environments of the application.

In one embodiment of the present invention, generating the set of environment-level sustainability scores for the application further includes determining a weight to apply to the component sustainability score for the components of the component set that corresponds to the environment from the group of environments of the application based on a power consumption of the components of the component set that corresponds to the environment from the group of environments of the application. The method further includes generating the set of environment-level sustainability scores by averaging the component sustainability score for the components of the component set that corresponds to the environment from the group of environments of the application.

In one embodiment of the present invention, the obtaining the component set that corresponds to the environment from the group of environments of the application further includes generating a knowledge graph using the application data. The method also includes obtaining the component set that corresponds to the environment from the group of environments of the application by providing the knowledge graph, energy consumption metrics, carbon emission metrics, and location and cloud provider data to an artificial intelligence engine.

In one embodiment of the present invention, the generating the application sustainability score using the set of environment-level sustainability scores for the application and the application maturity score further includes averaging the application maturity score and each environment-level sustainability score of the set of environment-level sustainability scores.

In one embodiment of the present invention, the recommendation is an anomaly detection and root cause analysis recommendation, a rightsizing recommendation, or a green resource alternative recommendation.

According to another non-limiting embodiment of the invention, a system having a memory having computer readable instructions and one or more processors for executing the computer readable instructions, the computer readable instructions controlling the one or more processors to perform operations. The operations include receiving first data, second data, and third data. The operations also include generating a set of environment-level sustainability scores for an application using the first data, the second data, and the third data, wherein the set of environment-level sustainability scores corresponds to an environment of a group of environments of the application. The operations further include generating an application maturity score using the third data. The operations also include generating an application sustainability score using the set of environment-level sustainability scores for the application and the application maturity score. The operations further include generating a recommendation for the application based on the application sustainability score. The operations also include initiating a modification to a datacenter of the application based on the recommendation for the application.

According to another non-limiting embodiment of the invention, a computer program product is provided. The computer program product includes a computer-readable storage medium having program instructions embodied therewith, the program instructions executable by a processor to cause the processor to perform operations. The operations include receiving first data, second data, and third data. The operations also include generating a set of environment-level sustainability scores for an application using the first data, the second data, and the third data, wherein the set of environment-level sustainability scores corresponds to an environment of a group of environments of the application. The operations further include generating an application maturity score using the third data. The operations also include generating an application sustainability score using the set of environment-level sustainability scores for the application and the application maturity score. The operations further include generating a recommendation for the application based on the application sustainability score. The operations also include initiating a modification to a datacenter of the application based on the recommendation for the application.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for sustainability scoring and recommendations for application services in a computing environment in accordance with one or more embodiments of the present invention;

FIG. 3 is a data flow diagram sustainability scoring and recommendations for application services in a computing environment in accordance with one or more embodiments of the present invention;

FIG. 4 is a data flow diagram for a component detector for sustainability scoring and recommendations for application services in accordance with one or more embodiments of the present invention;

FIG. 5 is a data flow diagram for an application maturity engine for sustainability scoring and recommendations for application services in a computing environment in accordance with one or more embodiments of the present invention;

FIG. 6 is a data flow diagram for determining component sustainability scoring for sustainability scoring and recommendations for application services in a computing environment in accordance with one or more embodiments of the present invention;

FIG. 7 is a data flow diagram for determining an application sustainability score for sustainability scoring and recommendations for application services in a computing environment in accordance with one or more embodiments of the present invention;

FIG. 8 is a data flow diagram for a recommendation engine for sustainability scoring and recommendations for application services in a computing environment in accordance with one or more embodiments of the present invention;

FIG. 9 is a flowchart of a computer-implemented method for sustainability scoring and generating a recommendation in a computing environment in accordance with one or more embodiments of the present invention;

FIG. 10 depicts a cloud computing environment in accordance with one or more embodiments of the present invention; and

FIG. 11 depicts abstraction model layers in accordance with one or more embodiments of the present invention.

### DETAILED DESCRIPTION

Disclosed herein are methods, systems, and computer program products for a sustainability scoring and recommendation system for application services. As discussed above, obtaining data to measure the sustainability performance of an application is difficult. Current systems do not have standardized metrics for measuring application sustainability, making it challenging to compare the sustainability performance across different applications.

The systems and methods described herein are directed to providing an effective measurement of sustainability for applications and application services, which can be used to sustainably optimize efficiency and costs associated with an application while minimizing its environmental impacts. The sustainability scoring and recommendation system analyzes the architecture of the cloud solution of an identified application and identifies workloads, applications, and components that contribute to the environmental impact of an application. The systems and methods described herein provide continuous sustainability analysis and automation to identify opportunities from functional and non-functional application requirements at any stage of the software development process of the application. Additionally, the sustainability scoring and recommendation system generates sustainability-driven efficiency and cost optimization recommendations for the computing infrastructure associated with the application that aim to reduce the negative environmental impacts of the application. An application includes one or more pieces of software executable on a computer system of the computing infrastructure.

In some embodiments, the system receives data associated with an application or application service that is currently in the development process. The data can include requirements documents for the application or application service, architecture artifacts of the application or application service, and/or system context artifacts of the application or application service. The data is analyzed and processed using artificial intelligence to identify components of the application that are prone to carbon or greenhouse gas emissions. In some embodiments, artificial intelligence (AI) engines use the data associated with the application or application service as well as data from a computing infrastructure or datacenter associated with the application or application service to identify components of the application or application service that are prone to carbon emissions or greenhouse gas emissions and their corresponding percentage of power consumption of the overall application or application service.

In some embodiments, the system generates environment-level sustainability scores for each environment of the application. The environments of the application correspond to the different stages of software development and deployment, such as development, quality assurance, pre-production, production, and the like. The system generates the environment-level sustainability scores by using the component sustainability scores of the components associated with the environment.

In some embodiments, the system generates an application maturity score for an application. An application maturity score for an application indicates a level of reliability and dependability of an application and its components when compared to application maturity guidelines set forth by subject matter experts. In some embodiments, the application maturity score is used to evaluate the level of sustainability achievable by the application upon modification of one or more components of the application. The system generates an application sustainability score using the application maturity score and all of the environment-level sustainability scores generated for the application.

The systems and methods described herein are further directed to a sustainability scoring and recommendation system that generates recommendations based on the generated application sustainability score to decrease the environmental impact of the application. In some embodiments, the recommendations can include actions that identify irregularities in resource utilization and the underlying issues causing the irregularities, actions that upscale or downscale resources to match workload demands, and action that identify opportunities for transitioning components of a computing infrastructure to environmentally sustainable options based on resource location and configuration. Such actions are directed to align with sustainability goals of an organization and reducing long-term operational inefficiencies/costs of the computing infrastructure while reducing negative environmental impacts caused by the computing infrastructure.

Although the systems and methods described herein are characterized in the context of an application or application service, it should be appreciated that aspects of one or more embodiments can be applied to many different scenarios for reducing the environmental impact of components of a computing infrastructure.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

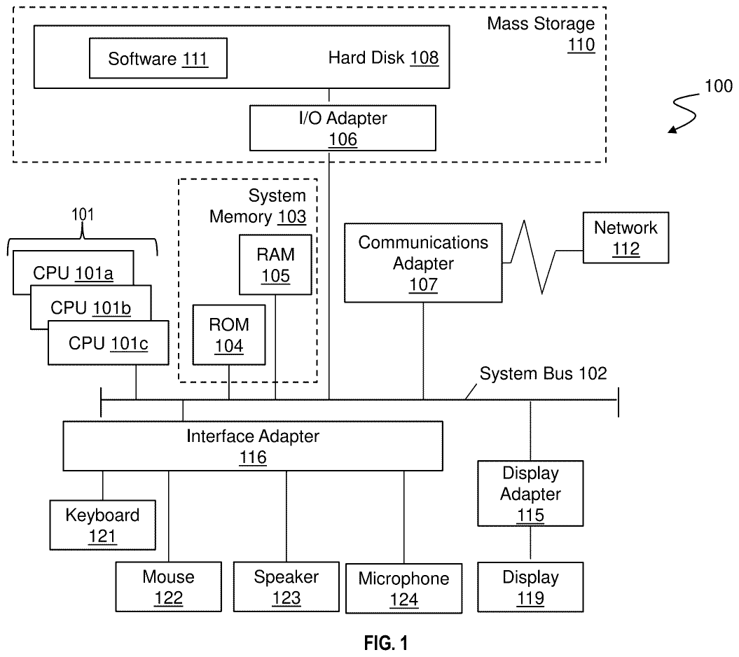

Turning now to FIG. 1, a computer system 100 is generally shown in accordance with one or more embodiments of the invention. The computer system 100 can be an electronic computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, a desktop computer, a laptop computer, a tablet computer, or a smartphone. In some examples, the computer system 100 may be a cloud computing node. The computer system 100 may be described in the general context of computer system executable instructions, such as program modules, being executed by a computer system. Generally, program modules may include routines, programs, objects, components, logic, data structures, and so on that perform tasks or implement abstract data types. The computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, a multi-core processor, a computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

The software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

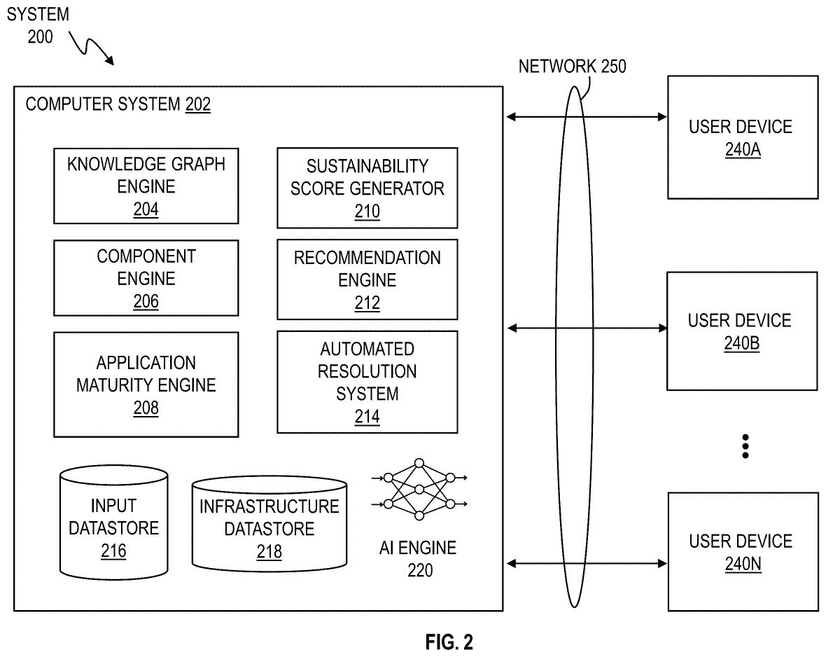

FIG. 2 depicts a block diagram of an example system 200 for a sustainability scoring and recommendation system for application services in a computing environment according to one or more embodiments. The system 200 includes a computer system 202 configured to communicate over a network 250 with many different user devices, such as a user device 240A, a user device 240B, through a user device 240N. The user devices 240A, 240B, through 240N can generally be referred to as user device 240 and are utilized to access the computing environment. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, a knowledge graph engine 204, a component engine 206, an application maturity engine 208, a sustainability score generator 210, a recommendation engine 212, an automated resolution system 214, an input datastore 216, an infrastructure datastore 218, an artificial intelligence (AI) engine 220, etc., can include functionality and features of the computer system 100 in FIG. 1, including various hardware components and various software applications, such as the software 111, which can be executed as instructions on one or more processors 101 in order to perform actions according to one or more embodiments of the invention. The knowledge graph engine 204, component engine 206, application maturity engine 208, sustainability score generator 210, recommendation engine 212, automated resolution system 214, input datastore 216, infrastructure datastore 218, and/or AI engine 220 can include, be integrated with, and/or call other pieces of software, algorithms, application programming interfaces (APIs), etc., to operate as discussed herein.

In some embodiments, the computer system 202 can include one or more modules to monitor and generate sustainability scores for application services that indicate the environmental impact of an application service and its components on the computing environment and generate recommendations based on the sustainability scores. For example, the computer system 202 can include a knowledge graph engine 204, a component engine 206, an application maturity engine 208, a sustainability score generator 210, a recommendation engine 212, an automated resolution system 214, an input datastore 216, an infrastructure datastore 218, and/or an AI engine 220.

In some embodiments, the knowledge graph engine 204 of the computer system 202 receives data for an application or application service (e.g., data associated with the development of an application). Examples of the data can include, but are not limited to, requirements documents, architecture artifacts of the application (e.g., drawings, figures, schematics, etc.), system context artifacts of the application, and the like. In some embodiments, the data received may be stored in the input datastore 216.

In some embodiments, the knowledge graph engine 204 can facilitate generation of a knowledge graph using the data. The knowledge graph engine 204 communicates with one or more AI engine(s) 220 to use the data to generate a knowledge graph. In some embodiments, the AI engine(s) 220 may use one or more known techniques of natural language processing and deep learning methods to generate the knowledge graph. In some embodiments, the knowledge graph engine 204 and AI engine 220 may utilize known methods of name entity recognition and relation extraction to build the knowledge graph. The knowledge graph engine 204 transmits the knowledge graph to a component engine 206.

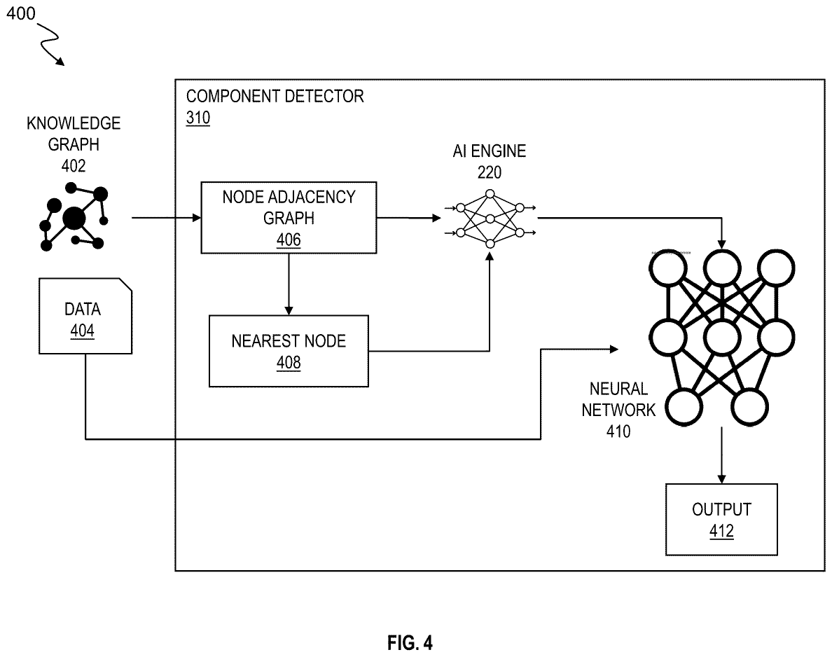

In some embodiments, the component engine 206 of the computer system 202 identifies components of an application in a given environment that are prone to carbon or greenhouse gas emissions. The component engine 206 receives the knowledge graph from the knowledge graph engine 204. The component engine 206 receives data from a computing infrastructure or datacenter associated with the application. Examples of data received from the computing infrastructure or the datacenter can include, but is not limited to, energy consumption metrics of the computing infrastructure or the datacenter, carbon emissions metrics of the computing infrastructure or the datacenter, water consumption metrics of the computing infrastructure or the datacenter, cloud provider data, location data, and the like. The component engine 206 communicates with one or more AI engines 220 to determine a percentage of energy consumption by the component using the knowledge graph and the data receives from the computing infrastructure or the datacenter. In some embodiments, the component engine 206 may generate a component sustainability score for each identified component of the application. In some embodiments, the component engine 206 can communicate with one or more AI engines 220 to generate component sustainability scores for each identified component. The AI engine 220 uses one or more techniques of deep learning regression and takes as input the utilization metrics and power consumption of the components, the knowledge graph, data from the computing infrastructure or the datacenter, and other information to generate a component sustainability score for each identified component of the application that is prone to carbon emissions, as further discussed in relation to FIG. 4.

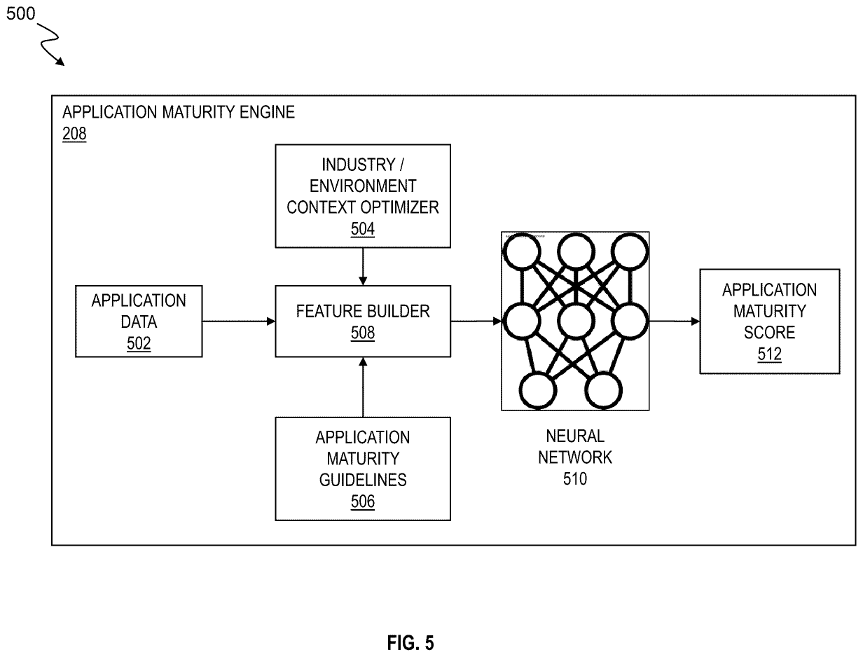

In some embodiments, the application maturity engine 208 of the computer system 202 generates an application maturity score for the application. An application maturity score for an application indicates a level of reliability and dependability of an application and its components when compared to application maturity guidelines set forth by subject matter experts. In some embodiments, the application maturity score can be used to evaluate the level of sustainability achievable by the application upon modification of one or more components of the application. The application maturity engine 208 is discussed in further detail in relation to FIG. 5.

The sustainability score generator 210 receives the application maturity score from the application maturity engine 208 and the components identified by the component engine 206 with their corresponding percentage of energy consumption and their respective component sustainability scores.

The sustainability score generator 210 generates an environment-level sustainability score for each environment associated with the application. Examples of environments of the application can include environments that correspond to stages of software development (e.g., development, quality assurance, pre-production, staging, production, etc.). The sustainability score generator 210 generates environment-level sustainability scores that correspond to an environment of the application using the component sustainability scores of the components that are associated with the identified environment.

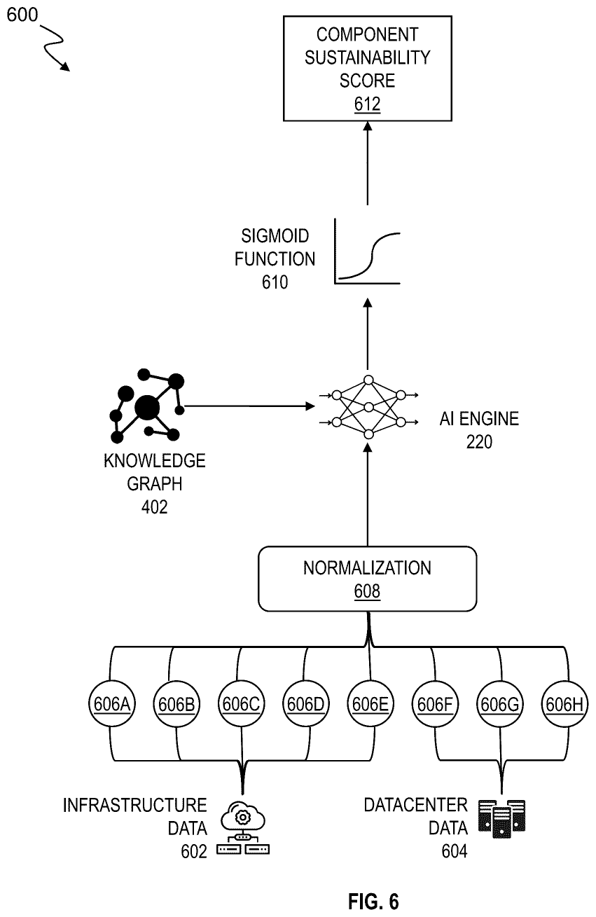

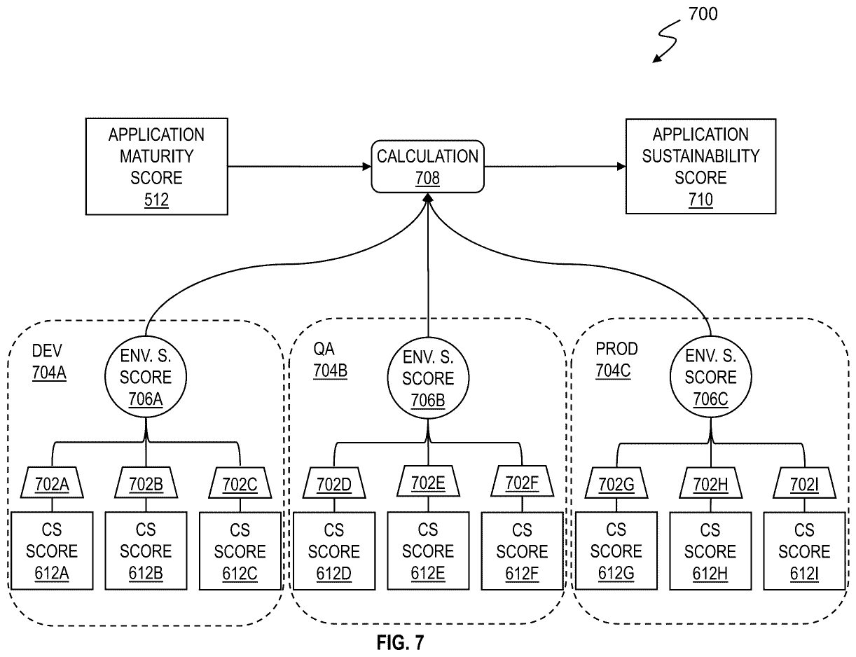

In some embodiments, the sustainability score generator 210 may generate an application sustainability score using the environment-level sustainability scores and the application maturity score generated by the application maturity engine 208. Calculation of the sustainability scores for components, environments, and the application are further discussed in detail with regard to FIGS. 6 and 7.

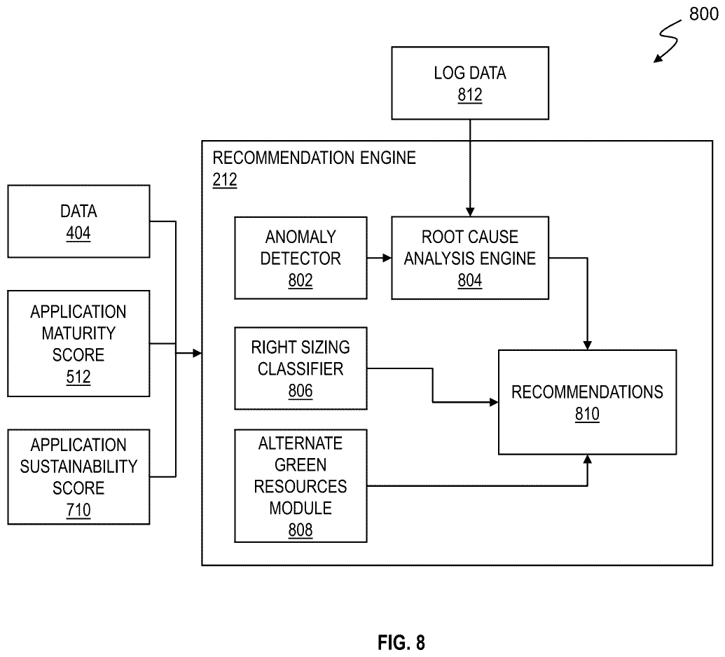

In some embodiments, the recommendation engine 212 receives the component sustainability scores, the environment-level sustainability scores, the application sustainability score, the application maturity score, and/or data from the computing infrastructure or the datacenter. The recommendation engine 212 optimizes cloud resource utilization and enhances sustainability of the computing infrastructure or the datacenter by generating recommendations based on the sustainability scores of the components, environments, and application and other data received, which are further discussed in relation to FIG. 8.

In one or more embodiments, the computer system 202 includes and/or is coupled to an automated resolution system 214. Based on the recommendations generated by the recommendation engine 212, the automated resolution system 214 is configured to modify software components, hardware components, and/or both software and hardware components of one or more user devices 240 in the computing environment, thereby resulting in improvements to the computer systems themselves. The improvements can include updates to software, software patches, increased memory, released/decreased memory, increased/decreased CPU capability, increased/decreased I/O functionality, improved cybersecurity software, etc. The modifications to the software and/or hardware components solve technical computer problems on the computer systems in the computing environment and are practical applications associated with use of the optimal recommendation. In one or more embodiments, the remediation action in the recommendation is executed to sustainably optimize costs and/or reduce an environmental impact of the application or component to the environment. In some embodiments, if an application sustainability score meets a designated threshold value, the automated resolution system 214 performs one or more actions of a recommendation that makes modifications to the software and/or hardware components. Although example values for the application sustainability score are illustrated, execution of the action in the recommendation is not limited to meeting the example threshold values for the application sustainability score.

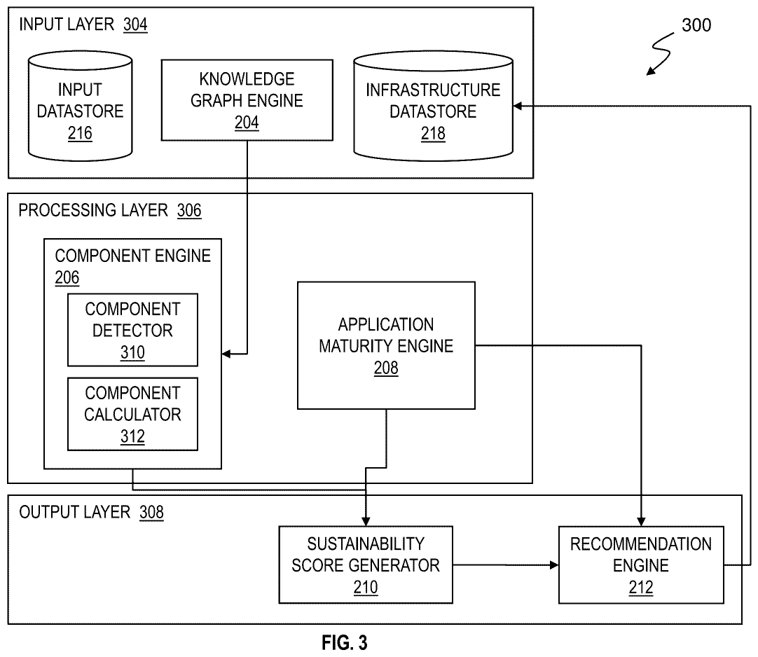

Now referring to FIG. 3, a data flow diagram 300 for a sustainability scoring and recommendation system for application services in a computing environment is depicted. In one embodiment, the sustainability scoring and recommendation system includes an input layer 304, a processing layer 306, and an output layer 308.

The input layer 304 includes modules to receive and store data. For example, the input layer 304 receives data associated with the development of the application, such as software or application requirements documents, computer architecture artifacts, system context artifacts, and the like. In some embodiments, the data can be received and stored in a datastore, such as input datastore 216. The input layer 304 also receives data from a computing infrastructure or datacenter associated with the application. Examples of data received from the computing infrastructure or the datacenter can include energy consumption metrics of the computing infrastructure or the datacenter, carbon emissions metrics of the computing infrastructure or the datacenter, water consumption metrics of the computing infrastructure or the datacenter, cloud provider data, location data, and the like. In some embodiments, the data received from the computing infrastructure or the datacenter can be stored in a datastore, such as infrastructure datastore 218.

In some embodiments, the input layer 304 may include the knowledge graph engine 204. The knowledge graph engine 204 communicates with one or more AI engines 220 to generate a knowledge graph using the data associated with the development of the application. In some embodiments, the AI engine(s) 220 use one or more known techniques of natural language processing and deep learning methods to generate the knowledge graph. The knowledge graph engine 204 and AI engine 220 may utilize known methods of name entity recognition and relation extraction to build the knowledge graph. The knowledge graph engine 204 transmits the knowledge graph to a component engine 206.

The processing layer 306 of the sustainability scoring and recommendation system includes the component engine 206 and the application maturity engine 208. In some embodiments, the component engine 206 may receive the knowledge graph generated by the knowledge graph engine 204 and data received from the computing infrastructure or the datacenter. In some embodiments, the component detector 310 of the component engine 206, in conjunction with one or more AI engines 220, uses the knowledge graph and the data received from the computing infrastructure or the datacenter to identify the components of the application that are more prone to carbon or greenhouse gas emissions and a corresponding percentage of energy consumption of the identified component compared to the overall application.

In some embodiments, the component calculator 312 of the component engine 206 can generate a component sustainability score for each identified component of the application. In some embodiments, the component calculator 312 can instruct the AI engine 220 to use the utilization metrics and power consumption of the components identified by the component detector 310, the knowledge graph, and other information to generate a component sustainability score for each identified component of the application that is prone to carbon or greenhouse gas emissions.

The processing layer 306 also includes the application maturity engine 208 of the computer system 202. The application maturity engine 208 generates an application maturity score for an application. The application maturity engine 208 analyzes the different individual layers that make up the application. The application maturity engine 208 uses an application maturity guideline developed by subject matter experts for each of the capabilities of the application, such as dependency management and performance optimization, to assess the application and its maturity. The application maturity engine 208 generates an application maturity score that indicates the maturity level of the overall application.

The output layer 308 of the sustainability scoring and recommendation system includes the sustainability score generator 210 and the recommendation engine 212. In some embodiments, the sustainability score generator 210 receives a set of components identified by the component detector 310 as prone to carbon or greenhouse gas emissions for each environment associated with the application and their respective component sustainability scores. The sustainability score generator 210 receives the application maturity score from the application maturity engine 208. In some embodiments, the sustainability score generator 210 generates an environment-level sustainability score for each environment associated with the application using the component sustainability scores of the components that are associated with the identified environment. In some embodiments, the sustainability score generator 210 can then generate an application sustainability score using the environment-level sustainability scores and the application maturity score generated by the application maturity engine 208. In some embodiments, the application sustainability score may have a value between 1 and 100. A lower score can indicate a more negative environmental impact of the application, while a higher score can indicate that the application has a minimal environmental impact.

In some embodiments, the recommendation engine 212 can receive the application sustainability score as well as additional data from other layers, such as the component sustainability scores, the environment-level sustainability scores, the application maturity score, and/or the data from the computing infrastructure or the datacenter. The recommendation engine 212 generates recommendations based on the sustainability scores of the components, environments, and application and other data received. In some embodiments, one or more recommendations are presented to a user of the system. Upon receiving an indication of a selection of a recommendation, the automated resolution system 214 implements actions of the recommendation, which can include one or more modifications to the computing infrastructure of the application or the datacenter associated with the application.

Now referring to FIG. 4, a data flow diagram 400 for a component detector 310 of a sustainability scoring and recommendation system for application services in accordance with one or more embodiments of the present invention is depicted. As discussed above, the component detector 310 of the component engine 206 identifies which components of an application or applications service in a given environment are more prone to carbon or greenhouse gas emissions and determines a percentage of power consumption by the identified component in the context of the overall application. In some embodiments, the component detector 310 receives the knowledge graph 402 generated by the knowledge graph engine 204 of the input layer 304. The component detector 310 directs one or more AI engines 220 to use deep learning techniques to identify nearest nodes 408 by applying the knowledge graph 402 to a node adjacency graph 406 of the computing infrastructure, which generates graph embeddings. The AI engine 220 can use data 404 received from the input layer 304 for the computing infrastructure or the datacenter associated with the application. Examples of the data 404 received may include energy consumption metrics of the different elements of the computing infrastructure or datacenter, carbon emissions metrics, location data, and cloud provider data. The data 404 and the graph embeddings generated by the AI engine 220 are passed to the neural network 410. The neural network 410 has been trained using classification and regression models with appropriate activation functions. The output 412 generated by the neural network 410 is the identification of components of the application that are affected by carbon or greenhouse gas emissions and their respective percentage of power consumption. In some embodiments, the percentage of power consumption for components of the application may be a value between 0 and 100. If a component of the application is not prone to carbon emissions or greenhouse gas emissions, then the percentage of power consumption for that component is assigned a value of zero by the neural network 410.

Now referring to FIG. 5, a data flow diagram 500 for an application maturity engine 208 of a sustainability scoring and recommendation system for application services in a computing environment in accordance with one or more embodiments of the present invention is depicted. As discussed above, the application maturity engine 208 of the processing layer 306 generates an application maturity score 512 that indicates a level of reliability and dependability of an application and its components when compared to application maturity guidelines set forth by subject matter experts. The application maturity engine 208 receives and evaluates application data 502. Application data 502 can include metrics and information associated with the application, such as code review and analysis data, testing and coverage data, documentation quality data, dependencies management data, performance optimization data, security scans and compliance data, version control data, scalability and maintainability data, or the like.

The application maturity engine 208 includes an industry/environment context optimizer 504 that obtains information associated with an industry or environment that is associated with the application. Information obtained and/or maintained by the industry/environment context optimizer 504 can include industry standards information, trending or popular features or elements, and the like. The application maturity engine 208 includes an application maturity guideline 506 set by one or more subject matter experts for each of the capabilities of the application, such as dependency management and performance optimization.

In some embodiments, a feature builder 508 of the application maturity engine 208 receives the application data 502, information from the industry/environment context optimizer 504, and the application maturity guidelines 506. The feature builder 508 directs one or more AI engines 220 to build a model based on the received information which is then provided to a neural network 510 of the application maturity engine 208. The neural network 510 generates an application maturity score 512 using the model generated by the feature builder 508. The application maturity score 512 may be a value between 1 and 100 and is used to evaluate the level of sustainability achievable by modifying the application through actions in one or more recommendations generated by the recommendation engine 212.

Now referring to FIG. 6, a data flow diagram 600 for determining component sustainability scoring by a sustainability scoring and recommendation system for application services in a computing environment in accordance with one or more embodiments of the present invention is depicted. In some embodiments, the component detector 310 of the component engine 206 receives computing infrastructure data 602 and/or datacenter data 604 associated with an application. The component detector 310 analyzes each of the metrics 606A to 606H (collectively metrics 606) of the infrastructure data 602 and the datacenter data 604. Examples of the metrics can include resource utilization (e.g., percentage utilization), energy consumption, storage energy consumption, memory energy consumption, sustainable resources used or available, power usage effectiveness of the datacenter, CO2 estimates based on region, embodiment emission estimates, and the like. The component detector 310 normalizes 608 and cleans the metrics 606 prior to communicating the metrics to an AI engine 220. The AI engine 220 also receives the knowledge graph 402 generated from data associated with the application. The AI engine 220 identifies components of the application that are prone to carbon emissions or greenhouse gas emissions and generates a respective percentage of energy consumption by the identified component. In some embodiments, the component calculator 312 may generate the component sustainability scores 612 for each of the identified components of the application. In some embodiments, the component calculator 312 can use a function, such as f(x): alpha*(# green energy options available)+beta*(% of energy consumption of the component), to generate the component sustainability score 612. A sigmoid function 610 is applied to the component sustainability scores 612 for each of the identified components to ensure that the values of the component sustainability scores are scaled to a value between 0 and 100.

Referring now to FIG. 7, a data flow diagram 700 for determining an application sustainability score by a sustainability scoring and recommendation system for application services in a computing environment in accordance with one or more embodiments of the present invention is depicted. In some embodiments, the sustainability score generator 210 receives the component sustainability scores 612A to 6121 (collectively component sustainability scores 612) from the component calculator 312. In some embodiments, the sustainability score generator 210 may determine a weight 702A-702I (collectively weights 702) that indicates the relative power consumption of the component. The sustainability score generator 210 calculates an environment-level sustainability score 706A-706C (collectively environment-level sustainability scores 706) for each environment 704A to 704C (collectively environments 704) that corresponds to a software development stage, such as development 704A, quality assurance 704B, or production 704C. In some embodiments, the sustainability score generator 210 may average the component sustainability scores 612 of each environment 704. The component sustainability scores 612 are weighted by the weight 702 that indicates the relative power consumption of the component. For example, the sustainability score generator 210 can multiply the component sustainability scores 612A with weight 702A, component sustainability score 612B with weight 702B, and component sustainability score 612C with weight 702C. In the example depicted in FIG. 7, the component sustainability scores 612A, 612B, and 612C are associated with environment 704A, which corresponds to the “development” stage of the software development process. Accordingly, the sustainability score generator 210 averages the component sustainability scores 612A, 612B, and 612C to generate the environment-level sustainability score 706A that corresponds to environment 704A.

In some embodiments, the sustainability score generator 210 may use a function, such as f(x):

$${\sum }_{i - 1}^{N} ( env . sustainability score ) * ( \# of green components )$$

to generate the environment-level sustainability scores 706 of the application.

The sustainability score generator 210 calculates 708 the application sustainability score 710 using the application maturity score 512 and all of the environment-level sustainability scores 706A, 706B, and 706C of the application. In some embodiments, the sustainability score generator 210 uses a calculation 708 that averages the application maturity score 512 and all of the environment-level sustainability scores (e.g., 706A, 706B, and 706C) of the application.

Now referring to FIG. 8, a data flow diagram 800 for a recommendation engine 212 of a sustainability scoring and recommendation system for application services in a computing environment in accordance with one or more embodiments of the present invention is depicted. The recommendation engine 212 optimizes cloud resource utilization and enhances the sustainability of the computing infrastructure or the datacenter through the generation of three types of recommendations 810: anomaly detection and root cause analysis recommendations, rightsizing recommendations, and green resource alternative recommendations. In some embodiments, the recommendation engine 212 receives the application sustainability score 710, the application maturity score 512, and data 404. The recommendation engine 212 communicates with the anomaly detector 802 and the root cause analysis engine 804 to generate an anomaly detection and root cause analysis recommendation. The anomaly detector 802 uses the data 404 received from the computing infrastructure or the datacenter of the application to identify irregularities in resource utilization and pinpoint underlying issues. The root cause analysis engine 804 obtains log data 812 from the computing infrastructure or the datacenter to identify the root cause of the identified irregularities. The recommendation 810 generated by the anomaly detector 802 and the root cause analysis engine 804 include one or more actions to fix the underlying issues.

In some embodiments, the recommendation engine 212 may communicate with the right sizing classifier 806 to generate rightsizing recommendations. The right sizing classifier 806 categorizes events based on resource requirements and generates recommendations 810 that include one or more actions to upscale or downscale resources to match workload demands in order to optimize resource allocation and minimize costs.

In some embodiments, the recommendation engine 212 may communicate with the alternate green resources module 808. The alternate green resources module 808 analyzes the data 404 to identify opportunities for transitioning to environmentally sustainable options based on resource location and configuration. The alternate green resources module 808 uses the application maturity score 512 to determine the maturity level of the application and generates recommendations 810 to include one or more actions to transition the application to environmentally sustainable options based on resource location and configuration and adoption of energy-efficient or renewable energy-powered resources to align with sustainability goals and potentially reduce long-term operational costs.

In some embodiments, the recommendation engine 212 may facilitate generation of recommendations 810 based on the application sustainability score 710. For example, if the application sustainability score 710 is below a predetermined threshold (e.g., below 40), then the recommendation engine 212 can facilitate generation of the recommendation 810 by the anomaly detector 802 and the root cause analysis engine 804. If the application sustainability score 710 is between 40 and 80, then the recommendation engine 212 can facilitate generation of the recommendation 810 by the right sizing classifier 806. If the application sustainability score is above a predetermined threshold (e.g., above 80), then the recommendation engine 212 can facilitate generation of the recommendation 810 by the alternate green resources module 808.

In some embodiments, the recommendations 810 are presented to a user of the system with a request for a selection of one or more recommendations 810 to implement. The recommendation engine 212 receives a selection of recommendations 810 from the user and communicates with the automated resolution system 214 to implement the actions of the selected recommendation 810 to modify the computing infrastructure or the datacenter. In some embodiments, the automated resolution system 214 implements the actions of the generated recommendations if the application sustainability score 710 is below a predetermined threshold (e.g., below 80) and presents the recommendation to a user for review if the application sustainability score 710 is above the predetermined threshold (e.g., 80 and above).

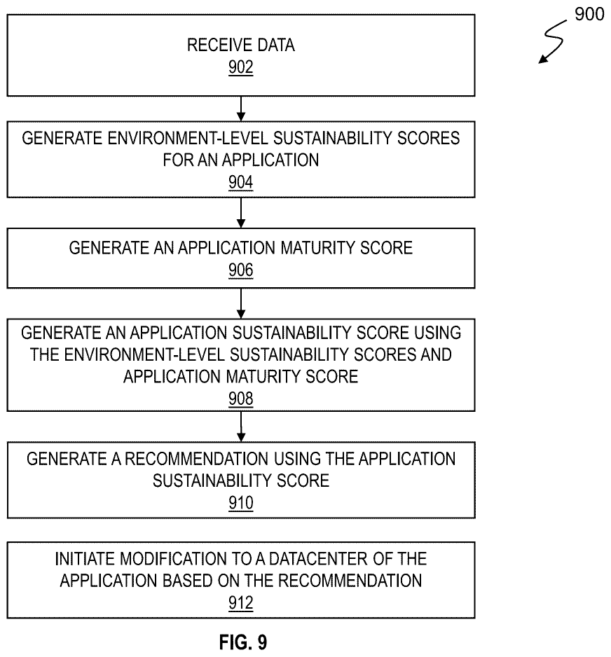

Now referring to FIG. 9, a flowchart depicts a computer-implemented method 900 for sustainability scoring and generating a recommendation in a computing environment. The computer-implemented method 900 is executed by the computer system 202. Reference can be made to any figures discussed herein.

At block 902 for the computer-implemented method 900, the knowledge graph engine 204 receives data 404. In some embodiments, the data 404 includes computing infrastructure data 602 as first data, datacenter data 604 as second data, and/or application data 502 as third data. In some embodiments, the knowledge graph engine 204 detects updates and/or changes made to a datastore, such as input datastore 216 and/or infrastructure datastore 218 and obtains the data in response to the detection. In some embodiments, a user of the system 200 manually provides data 404 to the system 200.

Next at block 904, environment-level sustainability scores are generated for an application. In some embodiments, the knowledge graph engine 204 instructs one or more AI engines 220 to utilize one or more known techniques of natural language processing and deep learning techniques to use the received data 404 to generate a knowledge graph 402. The knowledge graph 402 is transmitted to the component detector 310 of the component engine 206.

The component detector 310 facilitates one or more AI engines 220 in identifying components of an application in an environment that are prone to carbon emissions or greenhouse gas emissions. The AI engine 220 uses the knowledge graph 402 and the infrastructure data 602 and/or datacenter data 604 to identify the components of the application and determine corresponding percentage of energy consumption of the identified component.

In some embodiments, the component calculator 312 of the component engine 206 generates a component sustainability score 612 for each identified component of the application. In some embodiments, the component calculator 312 instructs the AI engine 220 to use the utilization metrics and power consumption of the components identified by the component detector 310, the knowledge graph 402, and other information to generate a component sustainability score 612 for each identified component of the application that is prone to carbon emissions.

In some embodiments, the sustainability score generator 210 generates an environment-level sustainability score 706 for each environment 704 associated with the application using the component sustainability scores 612 of the components that are associated with the identified environment 704. In some embodiments, the environment-level sustainability score 706 is calculated by averaging the score of the components within the environment 704 that is multiplied by the weight 702 of their relative power consumption.

At block 906 for the computer-implemented method 900, an application maturity score 512 is generated. In some embodiments, the application maturity engine 208 analyzes the application data 502, application maturity guidelines 506, and industry or environment contextual information, such as from an industry/environment context optimizer 504, to generate an application maturity score 512 that indicates the maturity level of the overall application.

At block 908, the sustainability scoring and recommendation system generates an application sustainability score 710 using the environment-level sustainability scores 706 and the application maturity score 512. In some embodiments, the sustainability score generator 210 receives the application maturity score from the application maturity engine 208. In some embodiments, the sustainability score generator 210 then generates an application sustainability score using the environment-level sustainability scores 706 for each environment 704 of the application and the application maturity score 512 generated by the application maturity engine 208. In some embodiments, sustainability score generator 210 generates the application sustainability score 710 by averaging the application maturity score 512 with all of the environment-level sustainability scores 706 of the application.

At block 910, a recommendation is generated using the application sustainability score 710. In some embodiments, the recommendation engine 212, receives the application sustainability score 710, the application maturity score 512, and data 404. In some embodiments, the recommendation engine 212 facilitates generation of a recommendation 810 by the anomaly detector 802 and root cause analysis engine 804 to identify irregularities in resource utilization and pinpoint underlying issues. The recommendation 810 is generated to include one or more actions to fix the underlying issues. In some embodiments, the recommendation engine 212 facilitates generation of a recommendation 810 by the right sizing classifier 806. The recommendation 810 is generated to include one or more actions to upscale or downscale resources to match workload demands to optimize resource allocation and minimize costs. In some embodiments, the recommendation engine 212 facilitates generation of a recommendation 810 by the alternate green resources module 808. The recommendation 810 is generated to include one or more actions to transition to environmentally sustainable options based on resource location and configuration, adoption of energy-efficient or renewable energy-powered resources to align with sustainability goals and potentially reduce long-term operational costs. In some embodiments, the recommendation engine 212 facilitates generation of recommendations 810 by the anomaly detector 802, root cause analysis engine 804, right sizing classifier 806, and the alternate green resources module 808 and prioritizes the recommendations 810 based on the application sustainability score 710. In some embodiments, the recommendation engine 212 uses the application sustainability score 710 to determine what type of recommendation 810 to generate. For example, if the application sustainability score 710 is below a predetermined threshold (e.g., below 40), then the recommendation engine 212 facilitates generation of the recommendation 810 by the anomaly detector 802 and the root cause analysis engine 804. If the application sustainability score 710 is between 40 and 80, then the recommendation engine 212 facilitates generation of the recommendation 810 by the right sizing classifier 806. If the application sustainability score is above a predetermined threshold (e.g., above 80), then the recommendation engine 212 facilitates generation of the recommendation 810 by the alternate green resources module 808.

At block 912, a modification to a datacenter of the application is made based on the generated recommendation 810. The recommendation engine 212 presents the generated recommendation 810 to a user of the system. In some embodiments, the recommendation engine 212 presents multiple generated recommendations 810 to a user and requests a selection of a recommendation 810 or a ranking of recommendations 810 to execute. The recommendation engine 212 receives the selection or ranking of recommendations 810 and communicates with the automated resolution system 214 to execute the actions of the selected recommendations 810 to modify the datacenter or computing infrastructure. In some embodiments, the recommendation engine 212 presents a recommendation 810 to a user of the system if the application sustainability score exceeds a predetermined threshold (e.g., higher than 80). If the application sustainability score is below the predetermined threshold (e.g., 80 or below), the recommendation engine 212 automatically communicates with the automated resolution system 214 to execute the actions of the generated recommendations 810.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

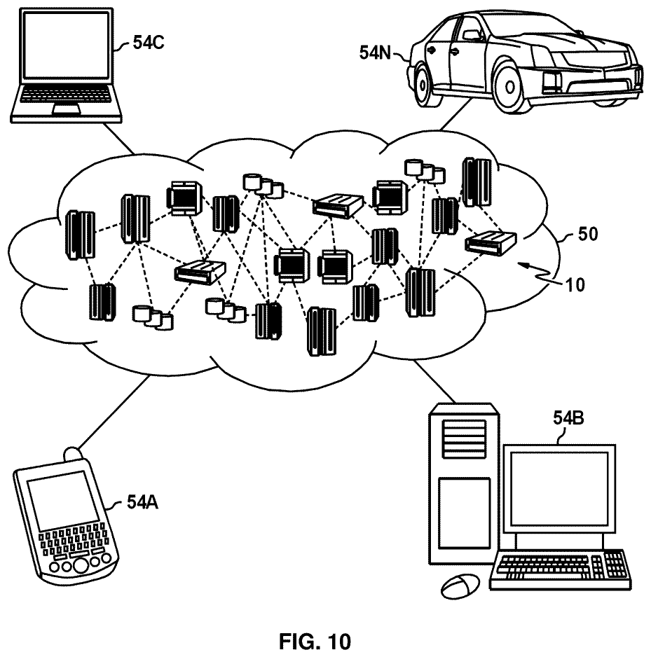

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

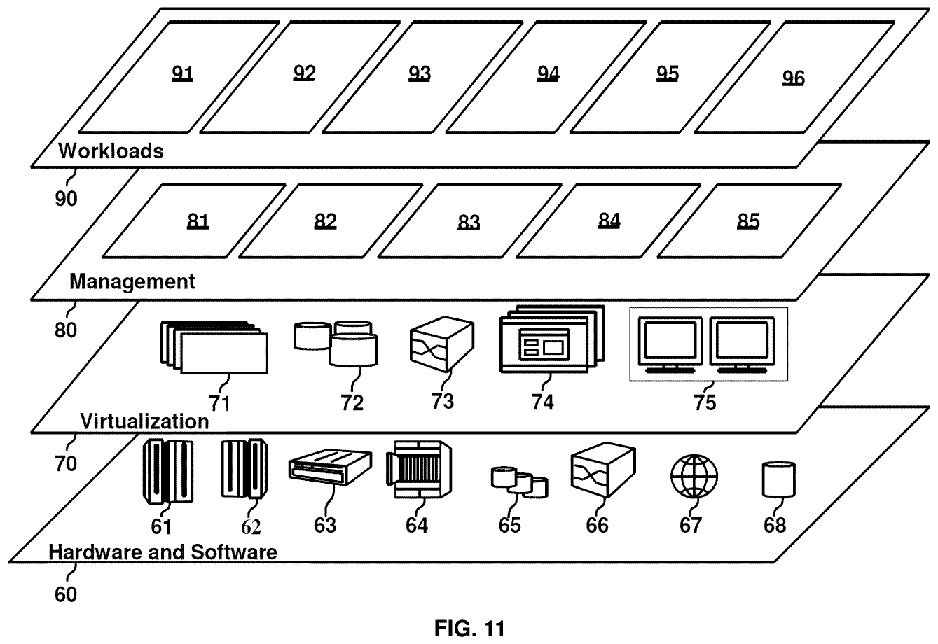

Referring now to FIG. 11, a set of functional abstraction layers provided by cloud computing environment 50 (depicted in FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. Examples of workloads and functions 96 includes generating sustainability scores for components of an application, environments of an application, and applications. Recommendations directed to sustainability-driven cost optimization and reduction in carbon emissions are generated based on the sustainability scores. The workloads and functions 96 include a system that modifies the computing infrastructure and/or the datacenter of an application based on a generated recommendation by the systems and methods described herein.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving first data, second data, and third data;
generating a set of environment-level sustainability scores for an application using the first data, the second data, and the third data, wherein the set of environment-level sustainability scores corresponds to an environment of a group of environments of the application;
generating an application maturity score using the third data;
generating an application sustainability score using the set of environment-level sustainability scores for the application and the application maturity score;
generating a recommendation for the application based on the application sustainability score; and
initiating a modification to a datacenter of the application based on the recommendation for the application.

2. The computer-implemented method of claim 1, wherein:
the third data comprises application data; and
the generating the application maturity score using the application data further comprises using application maturity guidelines, contextual data from an industry of the application, and information for layers of the application from the application data.

3. The computer-implemented method of claim 1, wherein:
the first data comprises computing infrastructure data, the second data comprises datacenter data, and the third data comprises application data;
the generating the set of environment-level sustainability scores for the application using the first data, the second data, and the third data further comprises:
obtaining a component set that corresponds to the environment from the group of environments of the application, the component set comprising components of the application that are prone to carbon emissions and carbon emission percentages corresponding to the components of the application;
generating a component sustainability score for the components of the component set that corresponds to the environment from the group of environments of the application using the carbon emission percentages, available sustainable resources from the datacenter data, sustainability and emissions data from the datacenter data, and the application data; and
generating the set of environment-level sustainability scores for the application, wherein environment-level sustainability scores of the set of environment-level sustainability scores is generated using the component sustainability score for the components of the component set that corresponds to the environment from the group of environments of the application.

4. The computer-implemented method of claim 3, wherein the generating the set of environment-level sustainability scores for the application further comprises:
determining a weight to apply to the component sustainability score for the components of the component set that corresponds to the environment from the group of environments of the application based on a power consumption of the components of the component set that corresponds to the environment from the group of environments of the application; and
generating the set of environment-level sustainability scores by averaging the component sustainability score for the components of the component set that corresponds to the environment from the group of environments of the application.

5. The computer-implemented method of claim 3, wherein the obtaining the component set that corresponds to the environment from the group of environments of the application further comprises:
generating a knowledge graph using the application data; and
obtaining the component set that corresponds to the environment from the group of environments of the application by providing the knowledge graph, energy consumption metrics, carbon emission metrics, and location and cloud provider data to an artificial intelligence engine.

6. The computer-implemented method of claim 1, wherein the generating the application sustainability score using the set of environment-level sustainability scores for the application and the application maturity score further comprises averaging the application maturity score and each environment-level sustainability score of the set of environment-level sustainability scores.

7. The computer-implemented method of claim 1, wherein the recommendation is an anomaly detection and root cause analysis recommendation, a rightsizing recommendation, or a green resource alternative recommendation.

8. A system comprising:
a memory having computer readable instructions; and
one or more processors for executing the computer readable instructions, the computer readable instructions controlling the one or more processors to perform operations comprising:
receiving first data, second data, and third data;
generating a set of environment-level sustainability scores for an application using the first data, the second data, and the third data, wherein the set of environment-level sustainability scores corresponds to an environment of a group of environments of the application;
generating an application maturity score using the third data;
generating an application sustainability score using the set of environment-level sustainability scores for the application and the application maturity score;
generating a recommendation for the application based on the application sustainability score; and
initiating a modification to a datacenter of the application based on the recommendation for the application.

9. The system of claim 8, wherein:
the third data comprises application data; and
operations for the generating the application maturity score using the application data further comprise using application maturity guidelines, contextual data from an industry of the application, and information for layers of the application from the application data.

10. The system of claim 8, wherein:
the first data comprises computing infrastructure data, the second data comprises datacenter data, and the third data comprises application data;
operations for the generating the set of environment-level sustainability scores for the application using the first data, the second data, and the third data further comprise:
obtaining a component set that corresponds to the environment from the group of environments of the application, the component set comprising components of the application that are prone to carbon emissions and carbon emission percentages corresponding to the components of the application;
generating a component sustainability score for the components of the component set that corresponds to the environment from the group of environments of the application using the carbon emission percentages, available sustainable resources from the datacenter data, sustainability and emissions data from the datacenter data, and the application data; and
generating the set of environment-level sustainability scores for the application, wherein environment-level sustainability scores of the set of environment-level sustainability scores is generated using the component sustainability score for the components of the component set that corresponds to the environment from the group of environments of the application.

11. The system of claim 10, wherein the operations for the generating the set of environment-level sustainability scores for the application further comprise:
determining a weight to apply to the component sustainability score for the components of the component set that corresponds to the environment from the group of environments of the application based on a power consumption of the components of the component set that corresponds to the environment from the group of environments of the application; and
generating the set of environment-level sustainability scores by averaging the component sustainability score for the components of the component set that corresponds to the environment from the group of environments of the application.

12. The system of claim 10, wherein the operations for the obtaining the component set that corresponds to the environment from the group of environments of the application further comprise:
generating a knowledge graph using the application data; and
obtaining the component set that corresponds to the environment from the group of environments of the application by providing the knowledge graph, energy consumption metrics, carbon emission metrics, and location and cloud provider data to an artificial intelligence engine.

13. The system of claim 8, wherein the operations for the generating the application sustainability score using the set of environment-level sustainability scores for the application and the application maturity score further comprise averaging the application maturity score and each environment-level sustainability score of the set of environment-level sustainability scores.

14. The system of claim 8, wherein the recommendation is an anomaly detection and root cause analysis recommendation, a rightsizing recommendation, or a green resource alternative recommendation.

15. A computer program product comprising a computer readable storage medium having program instructions embodied therewith, the program instructions executable by one or more processors to cause the one or more processors to perform operations comprising:
receiving first data, second data, and third data;
generating a set of environment-level sustainability scores for an application using the first data, the second data, and the third data, wherein the set of environment-level sustainability scores corresponds to an environment of a group of environments of the application;
generating an application maturity score using the third data;
generating an application sustainability score using the set of environment-level sustainability scores for the application and the application maturity score;
generating a recommendation for the application based on the application sustainability score; and
initiating a modification to a datacenter of the application based on the recommendation for the application.

16. The computer program product of claim 15, wherein:
the third data comprises application data; and
operations for the generating the application maturity score using the application data further comprise using application maturity guidelines, contextual data from an industry of the application, and information for layers of the application from the application data.

17. The computer program product of claim 15, wherein:
the first data comprises computing infrastructure data, the second data comprises datacenter data, and the third data comprises application data;
operations for the generating the set of environment-level sustainability scores for the application using the first data, the second data, and the third data further comprise:
obtaining a component set that corresponds to the environment from the group of environments of the application, the component set comprising components of the application that are prone to carbon emissions and carbon emission percentages corresponding to the components of the application;
generating a component sustainability score for the components of the component set that corresponds to the environment from the group of environments of the application using the carbon emission percentages, available sustainable resources from the datacenter data, sustainability and emissions data from the datacenter data, and the application data; and
generating the set of environment-level sustainability scores for the application, wherein environment-level sustainability scores of the set of environment-level sustainability scores is generated using the component sustainability score for the components of the component set that corresponds to the environment from the group of environments of the application.

18. The computer program product of claim 17, wherein the operations for the generating the set of environment-level sustainability scores for the application further comprise:
determining a weight to apply to the component sustainability score for the components of the component set that corresponds to the environment from the group of environments of the application based on a power consumption of the components of the component set that corresponds to the environment from the group of environments of the application; and
generating the set of environment-level sustainability scores by averaging the component sustainability score for the components of the component set that corresponds to the environment from the group of environments of the application.

19. The computer program product of claim 17, wherein the operations for the obtaining the component set that corresponds to the environment from the group of environments of the application further comprise:
generating a knowledge graph using the application data; and
obtaining the component set that corresponds to the environment from the group of environments of the application by providing the knowledge graph, energy consumption metrics, carbon emission metrics, and location and cloud provider data to an artificial intelligence engine.

20. The computer program product of claim 15, wherein the operations for the generating the application sustainability score using the set of environment-level sustainability scores for the application and the application maturity score further comprise averaging the application maturity score and each environment-level sustainability score of the set of environment-level sustainability scores.
